(19) United States
(12) Patent Application Publication
(10) Pub. No.: US 2014/0157525 A1
(43) Pub. Date: Jun. 12, 2014

(54) System for an Escaping Device

(71) Applicant: Ralphael T. Locklear, Shannon, NC (US)

(72) Inventor: Ralphael T. Locklear, Shannon, NC (US)

(21) Appl. No.: 14/102,881

(22) Filed: Dec. 11, 2013

Related U.S. Application Data
(60) Provisional application No. 61/735,860, filed on Dec. 11, 2012.

(51) Int. Cl. A62B 3/00; B60R 11/06

(52) U.S. Cl. CPC A62B 3/005; B60R 11/06
USPC 7/158

(57) ABSTRACT

A system for an escaping device includes an escape device and a holster as the escape device is secured within the holster by a locking mechanism. The holster is adjustably attached with a seatbelt of a vehicle by a seatbelt attachment mechanism, and the locking mechanism allows the users pull out the escape device from the holster when necessary. The escape device is completed with a LED, where the LED functions as a light source. A plurality of indentations within the escape device allows the users to firmly grip the escape device while the escape device is used to break windows or cut seatbelts as a glass breaking protrusion of the escape device enables to break the windows and a seatbelt cutter of the escape device enables to cut the seatbelts in an emergency situation.

The current application claims a priority to the U.S. Provisional Patent application Ser. No. 61/735,860 filed on Dec. 11, 2012.

### FIELD OF THE INVENTION

The present invention relates generally to an escape device. More specifically, the present invention is a device for cutting through a seatbelt, breaking the glass of a vehicle window, and otherwise assisting a person in escaping from a crashed vehicle. In its preferred embodiment, the present invention comprises a multifaceted device and an accompanying holster that are attached to a vehicle seatbelt. The device features a dual bladed cutter as well as a pointed edge for cutting a seatbelt and breaking a window, respectively.

### BACKGROUND OF THE INVENTION

Vehicular collisions and other accidents are dangerous and often life-threatening, particularly instances in which passengers become trapped or otherwise unable to escape from the vehicles. Passengers thrust into situations such as those involving overturned vehicles may find themselves unable to break free from seatbelts. Doors that have become disabled or impossible to open are additional obstacles faced by passengers escaping from vehicles. Without a means of overcoming these hurdles, passengers are presented with life-threatening situations whenever escape is a priority. The present invention seeks to provide a conveniently accessible and effective tool for facilitating escape from vehicles involved in collisions and other accidents.

The present invention is a device and holster that allow a passenger to quickly cut through a seatbelt, break through a vehicle window, and escape from a vehicle involved in a collision or other accident. The device features a dual bladed cutter for cutting through a seatbelt as well as a pointed edge for shattering a window. The device also features a light emitting diode (LED) that provides passengers with illumination in darkened vehicles. Alternative embodiments of the present invention may incorporate additional features onto the escape device. For example, an alternative embodiment of the device features a distress transmitter/beacon that transmits a signal upon activation alerting and notifying emergency rescue personnel of the location of a crash or other accident.

The escape device of the present invention is housed within an accompanying holster when not in use. The holster is designed to accommodate and secure the device while allowing quick and convenient access. Multiple means of attaching and securing the escape device to the holster are available. In the preferred embodiment of the present invention, the holster and secured device are both attached to a standard seatbelt strap by tucking and sliding the seatbelt strap into an accommodating slot present on the body of the holster.

### BRIEF DESCRIPTION OF THE DRAWINGS

FIG. 1 is a perspective view of the escape device of the present invention.

FIG. 2 is a top view of the escape device of the present invention.

FIG. 3 is a perspective view of the holster of the present invention.

FIG. 4 is another perspective view of the holster of the present invention.

FIG. 5 is a side view of the holster of the present invention, showing the bottom enclosure.

FIG. 6 is another side view of the holster of the present invention, showing the holster opening.

FIG. 7 is a perspective view of the escape device and the holster of the present invention secured to the seatbelt strap.

FIG. 8 is a top internal view of the escape device housed within the holster of the present invention and secured to the seatbelt strap.

FIG. 9 is a schematic view of the electrical connection of the present invention.

### DETAIL DESCRIPTIONS OF THE INVENTION

All illustrations of the drawings are for the purpose of describing selected versions of the present invention and are not intended to limit the scope of the present invention.

The present invention is a multifaceted device and accompanying holster that provides passengers of a vehicle with a means of cutting through a seatbelt strap, breaking a vehicle window, and escaping the vehicle. In its preferred embodiment, the present invention comprises an escape device 1 and a holster 4. The two primary components, which are the escape device 1 and the holster 4, of the present invention are secured to a standard seatbelt strap for quick and convenient access as the escape device 1 is secured within the holster 4.

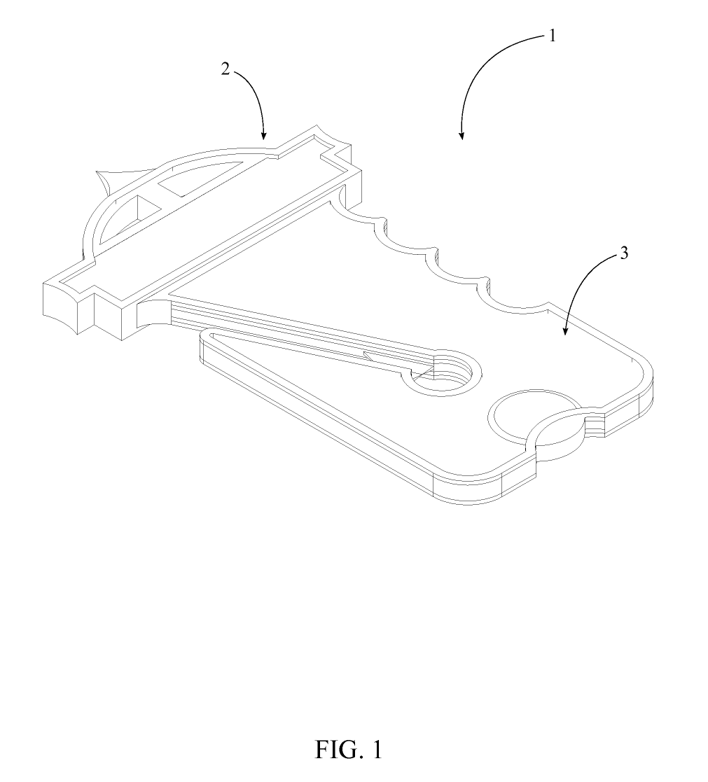

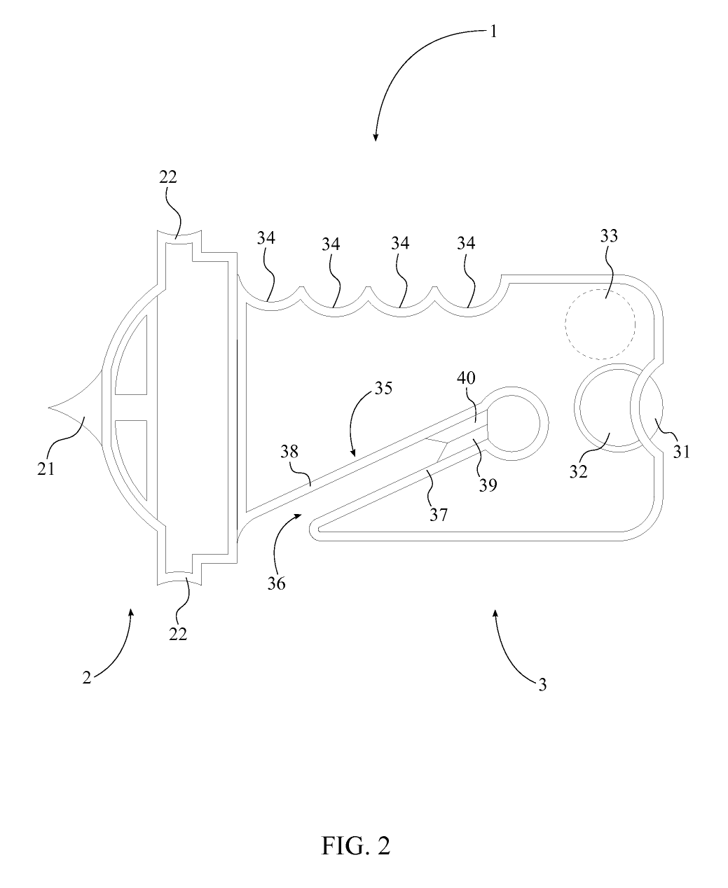

Referring to FIG. 1 and FIG. 2, in the preferred embodiment of the present invention, the escape device 1 comprises a first portion 2 and a second portion 3. The first portion 2 and the second portion 3 complete the general rectangular shape of the escape device 1 as the first portion 2 and the second portion 3 are adjacently positioned with each other.

In reference to FIG. 2, the first portion 2 comprises a glass breaking protrusion 21 and a locking mechanism 22. The glass breaking protrusion 21 is positioned on the first portion 2 in such way that the glass breaking protrusion 21 is oppositely positioned from the second portion 3. The glass breaking protrusion 21 is a slightly narrower and pointed extrusion of material that can be used to break a window of a vehicle, where the pointed extrusion of the material is not limited with respect to length or size. For example, the pointed extrusion may protrude a greater length to increase the distance between the passenger's hand and the breaking glass. It is highly advised that the passenger take measures to protect his or her hand from the broken glass of the window. This generally encompasses wearing a glove or wrapping the hand in thick cloth to prevent sharp glass from cutting the hand. The glass breaking protrusion 21 of the escape device 1 is then struck against a window to break the glass. The locking mechanism 22 is positioned on the first portion 2 so that the locking mechanism 22 is able to secure the escape device 1 within the holster 4. Even though a snap-locking mechanism is used as the locking mechanism 22 within the preferred embodiment, the locking mechanism 22 of the present invention can be any other type of locking mechanism such as, mechanical locking mechanisms, magnetic locking mechanisms, and structural locking mechanisms.

In reference to FIG. 2, the second portion 3 comprises a light emitting diode (LED) 31, a power switch 32, a battery compartment 33, a plurality of indentations 34, and a seatbelt cutter 35. The plurality of indentations 34 is perimetrically positioned on the second portion 3 in such way that the plurality of indentations 34 is adjacently positioned with the first portion 2. The plurality of indentations 34 is shaped and sized approximately to accommodate human fingers so that the users are able to securely grip the escape device 1. Each of the plurality of indentations 34 accommodates the index finger, the middle finger, the ring finger, and the pinky finger of the users as the users hold the escape device 1 sideway. For example, the plurality of indentations 34 enables a user to properly grip the escape device 1 in the event of breaking a window of a vehicle so that the maximum force can be applied to the window through the escape device 1 while minimizing the reaction force from the window.

In reference to FIG. 2, the seatbelt cutter 35, which comprises a recessed opening 36, a first railing 37, a second railing 38, a first blade 39, and a second blade 40, is diagonally extended into the second portion 3 opposite from the plurality of indentations 34, where the seatbelt cutter 35 is adjacently positioned with the first portion 2. More specifically, the recessed opening 36 is adjacently positioned with the first portion 2 and extended into the second portion 3 in between the first railing 37 and the second railing 38. The first railing 37 and the second railing 38 are oppositely positioned from each other so that the first blade 39 and the second blade 40 can be connected to the first railing 37 and the second railing 38. As for the first blade 39, the first blade 39 is connected to the first railing 37 and angularly extended into the recessed opening 36. As for the second blade 40, the second blade 40 is connected to the second railing 38 and angularly extended up to the first blade 39. The angular extension of the first blade 39 and the second blade 40 creates a v-shaped cutting edge in between the first blade 39 and the second blade 40 so that the seatbelt strap can be efficiently cut from both sides without compromising the structural integrity of the first railing 37 and the second railing 38. More specifically, when a user needs to cut the seatbelt strap, the user can insert the seatbelt strap into the recessed opening 36 and place against the first blade 39 and the second blade 40. Then the user can easily cut the seatbelt strap by the seatbelt cutter 35 as the escape device 1 is moved back and forth. The first railing 37 and the second railing 38 keep the seatbelt strap within the seatbelt cutter 35 so that the first blade 39 and the second blade 40 can easily cut though the seatbelt strap.

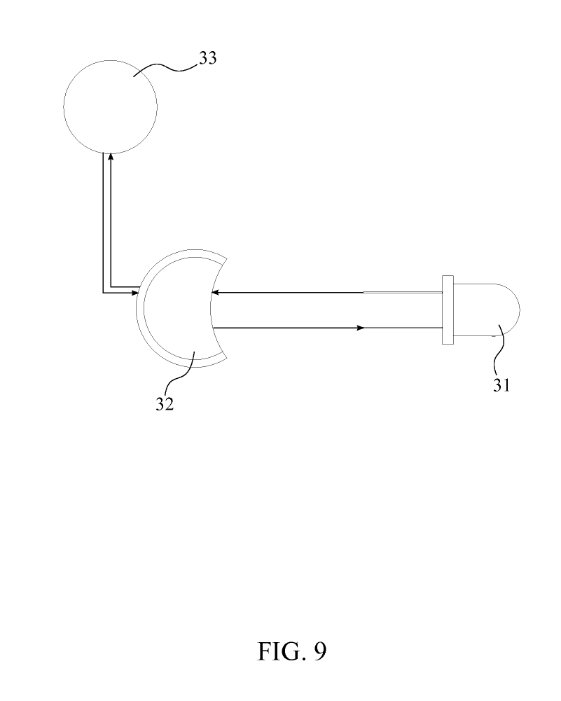

In reference to FIG. 2 and FIG. 9, the LED 31, the power switch 32, and the battery compartment 33 are electrically connected to each other within the escape device 1 so that the LED 31 can function as a light source when necessary. More specifically, the LED 31 is perimetrically positioned on the second portion 3 opposite from the first portion 2, and the power switch 32 is positioned on the second portion 3 adjacent to the LED 31 where the power switch 32 comprises an on-position and an off-position. The battery compartment 33 is positioned within the second portion 3 adjacent to the LED 31 and the power switch 32. When the power switch 32 is at the on-position, the electrical power from the battery compartment 33 travels to the LED 31 so that the escape device 1 can be used within darkened environments as the LED 31 functions as the light source. The LED 31 can be easily turned off as the off-position of the power switch 32 discontinuous the electrical power from the battery compartment 33. In the preferred embodiment of the present invention, the LED 31 is activated by placing pressure and squeezing the power switch 32 as the power switch 32 completes the electrical circuitry. Once the pressure is released from the power switch 32, the LED 31 is deactivated as the electrical circuitry becomes incomplete. However, alternative methods of activating the LED 31 can also be used within the present invention.

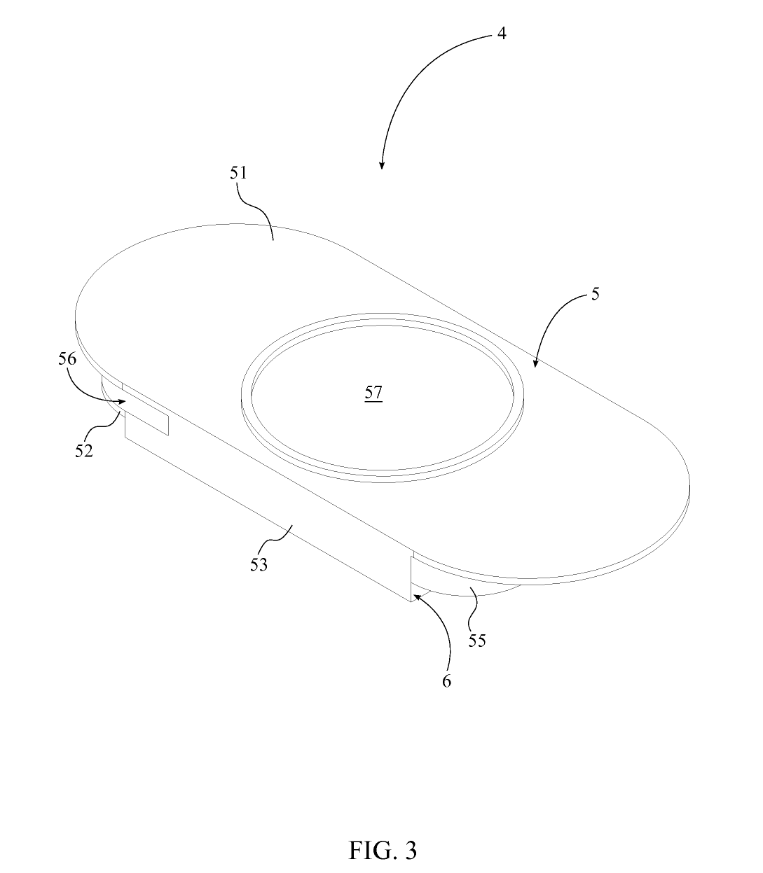

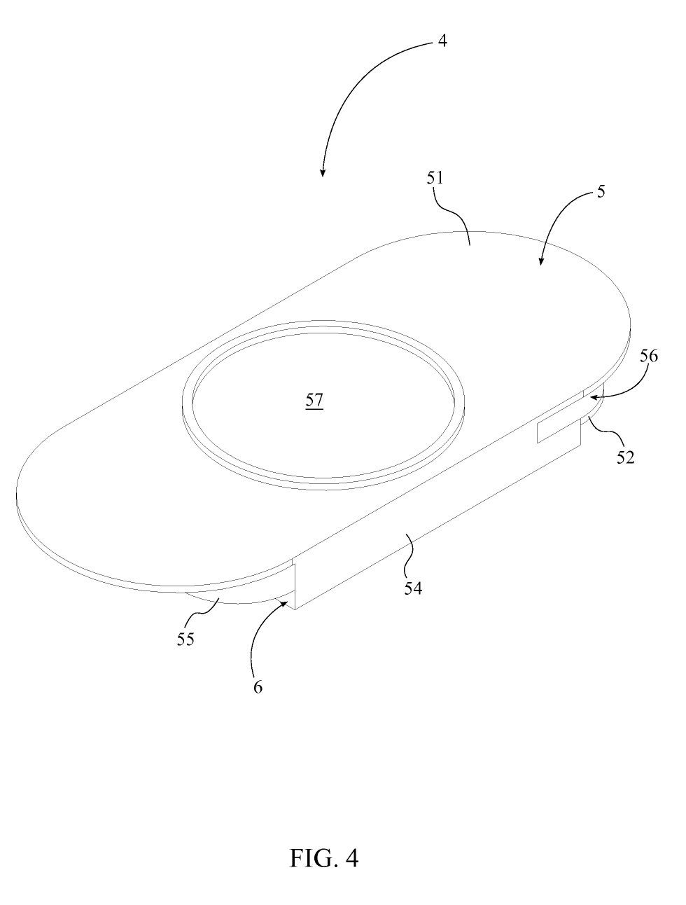

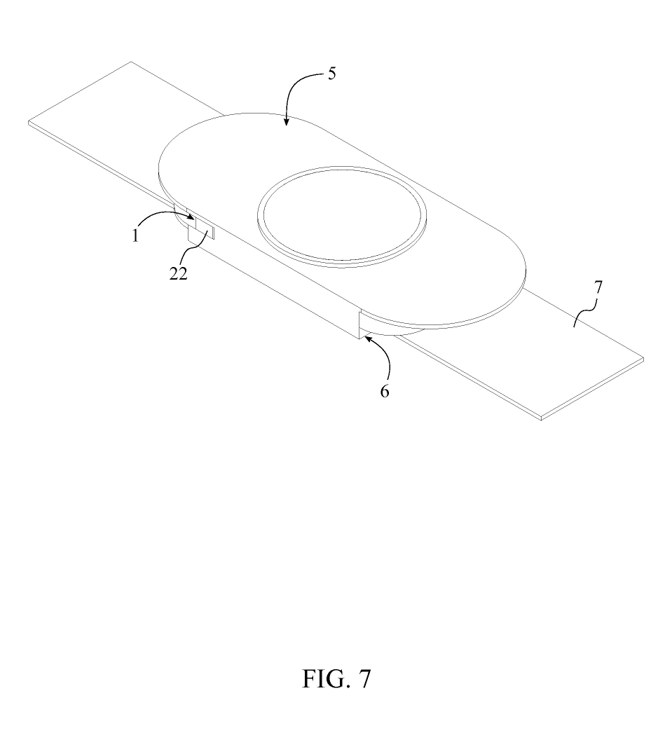

In reference to FIG. 3, FIG. 4, and FIG. 7, the holster 4 comprises a storage compartment 5 and a seatbelt attachment mechanism 6, where the storage compartment 5 is adjacently connected atop the seatbelt attachment mechanism 6. The seatbelt attachment mechanism 6 is removably and adjustably attached with a seatbelt 7 of a vehicle, where the holster 4 maintains a relatively low profile when attached to the seatbelt 7. Since the seatbelt attachment mechanism 6 connects the holster 4 with the seatbelt 7, the users can adjust the holster 4 along the seatbelt 7, preferably at chest level, so that the escape device 1 can be easily reached within arm's length. However, the holster 4 may be attached at any location along the seatbelt 7 upon user's preference. In the preferred embodiment of the present invention, the holster 4 is secured to the seatbelt 7 by tucking and sliding the seatbelt 7 into the accommodating slot present on the seatbelt attachment mechanism 6, but the seatbelt attachment mechanism 6 can be any other type of attachment mechanism such as, magnetic attachments and mechanical attachments.

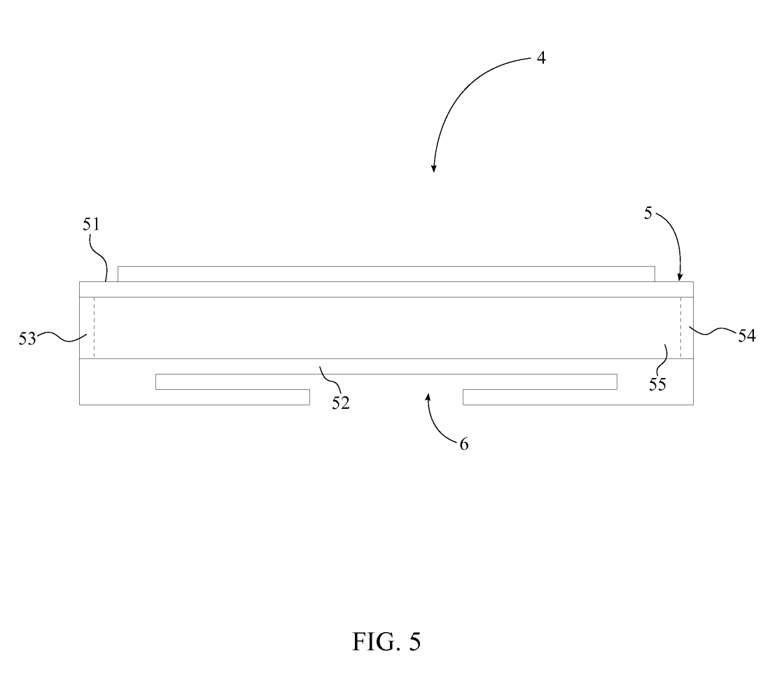

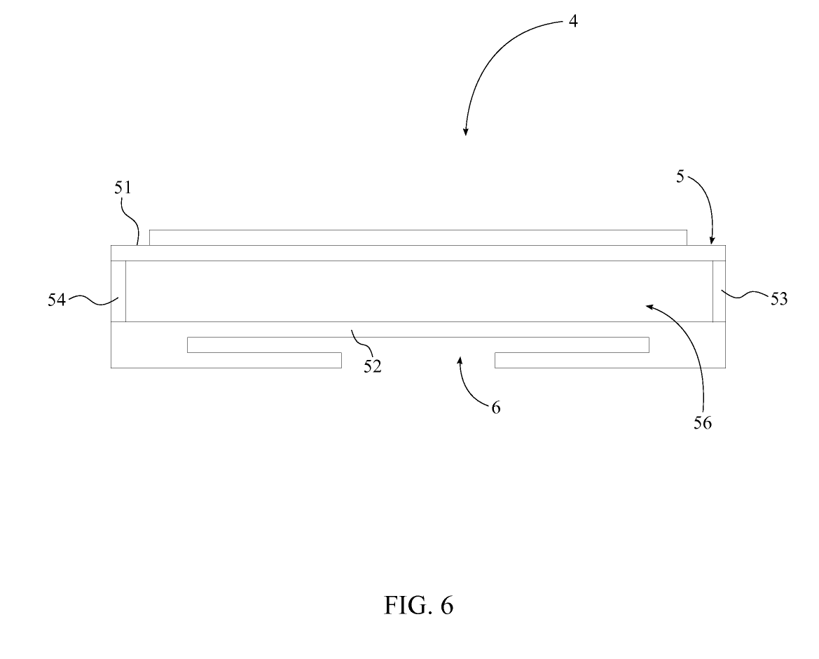

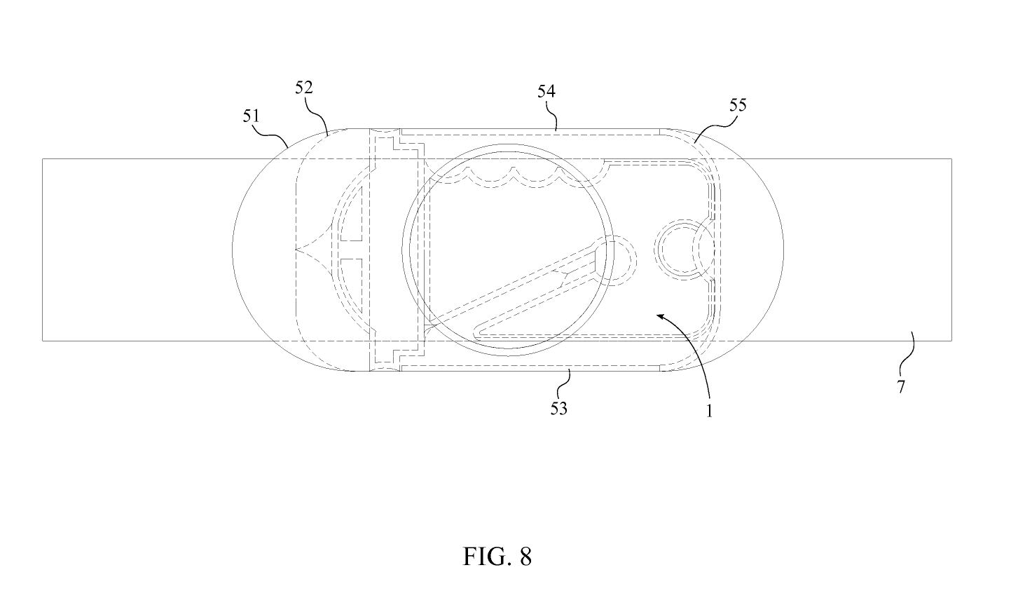

In reference to FIG. 3-FIG. 6, the escape device 1 is removably attached with the storage compartment 5 by the locking mechanism 22, where the storage compartment 5 comprises an exterior wall 51, an interior wall 52, a first lateral wall 53, a second lateral wall 54, a bottom enclosure 55, a holster opening 56, and a logo section 57. The interior wall 52 is adjacently positioned with the seatbelt attachment mechanism 6, and the exterior wall 51 is connected to the interior wall 52 by the first lateral wall 53 and the second lateral wall 54 as the exterior wall 51 is oppositely positioned from the seatbelt attachment mechanism 6. The first lateral wall 53 and the second lateral wall 54 are oppositely positioned from each other across the exterior wall 51 and the interior wall 52 in such way that the first lateral wall 53 and the second lateral wall 54 are perpendicularly positioned flush with the exterior wall 51 and the interior wall 52. The bottom enclosure 55 is positioned in between the first lateral wall 53, the second lateral wall 54, the exterior wall 51, and the interior wall 52 from an end so that the storage compartment 5 can be created within the holster 4 as the bottom enclosure 55 separates the exterior environment from the holster 4. The holster opening 56 is oppositely positioned from the bottom enclosure 55, where the holster opening 56 allows the users to access the storage compartment 5 as the holster opening 56 opens to the exterior environment. In reference to FIG. 7 and FIG. 8, the holster opening 56 allows the users insert the escape device 1 into the storage compartment 5 and pullout the escape device 1 from the storage compartment 5. The locking mechanism 22 of the present invention has to be strong enough to secure the escape device 1 in place while still allowing quick and convenient removal of the escape device 1. In the preferred embodiment, the locking mechanism 22 secures the escape device 1 within the holster 4 as the locking mechanism 22 snaps into the first lateral wall 53 and the second lateral wall 54. When the escape device 1 needs to be removed from the holster 4, the locking mechanism 22 is squeezed from both ends allowing the escape device 1 to disengage from the first lateral wall 53 and the second lateral wall 54.

In reference to FIG. 3 and FIG. 4, the logo section 57 is centrally positioned on the exterior wall 51 opposite from the interior wall 52, where the logo section 57 enable the present invention be to customizable with respect to different design themes and logo plates. For example, the logo section 57 can be customized according to different vehicle brands so that the present invention is able coexist with the existing design theme of a specific vehicle. Furthermore, the exterior wall 51, the first lateral wall 53, the second lateral wall 54, and the bottom enclosure 55 can also be customizable in alternative embodiment of the present invention. Further alternative embodiments of the present invention may include multifunctional illuminations within the logo section 57 in the form of the logo blinking as an indicator informing the passenger that his or her seatbelt strap is unbuckled.

The present invention is not limited with respect to material of the escape device 1. However, the material of the present invention is durable and light weighted enough that the glass breaking protrusion 21 may break a vehicle window while both the holster 4 and the escape device 1 are not uncomfortable for the user within the seatbelt 7.

Alternative embodiments of the present invention may incorporate features into the escape device 1 and the holster 4 in addition to those previously discussed. For example, an alternative embodiment of the present invention can include a distress transmitter/beacon housed within the escape device 1 or the holster 4, where the distress transmitter/beacon transmits a signal that alerts and notifies emergency rescue personnel of the location of a vehicular collision or other accident.

Although the invention has been explained in relation to its preferred embodiment, it is to be understood that many other possible modifications and variations can be made without departing from the spirit and scope of the invention as hereinafter claimed.

What is claimed is:

1. A system for an escaping device comprises:
an escape device;
a holster;
the escape device comprises a first portion and a second portion;
the first portion comprises a glass breaking protrusion and a locking mechanism;
the second portion comprises a light emitting diode (LED), a power switch, a battery compartment, a plurality of indentations, and a seatbelt cutter;
the holster comprises a storage compartment and a seatbelt attachment mechanism;
the first portion and the second portion being adjacently positioned with each other; and
the escape device being secured within the holster.

2. The system for an escaping device as claimed in claim 1 comprises:
the glass breaking protrusion being positioned on the first portion opposite from the second portion; and
the locking mechanism being positioned on the first portion.

3. The system for an escaping device as claimed in claim 1 comprises:
the plurality of indentations being perimetrically positioned on the second portion;
the plurality of indentation being adjacently positioned with the first portion;
the seatbelt cutter being diagonally extended into the second portion opposite from the plurality of indentations; and
the seatbelt cutter being adjacently positioned with the first portion.

4. The system for an escaping device as claimed in claim 3 comprises:
the seatbelt cutter comprises a recessed opening, a first railing, a second railing, a first blade, and a second blade;
the recessed opening being adjacently positioned with the first portion and extended into the second portion;
the first railing and the second railing being oppositely positioned each other;
the first blade being connected to the first railing and angularly extended into the recessed opening; and
the second blade being connected to the second railing and angularly extended up to the first blade.

5. The system for an escaping device as claimed in claim 1 comprises:
the LED being perimetrically positioned on the second portion opposite from the first portion;
the power switch being positioned on the second portion adjacent to the LED; and
the battery compartment being positioned within the second portion adjacent to the LED and the power switch.

6. The system for an escaping device as claimed in claim 1 comprises:
the LED, the power switch, and the battery compartment being electrically connected to each other.

7. The system for an escaping device as claimed in claim 1 comprises:
the storage compartment being adjacently connected atop the seatbelt attachment mechanism;
the escape device being removably attached with the storage compartment by the locking mechanism; and
the seatbelt attachment mechanism being removably and adjustably attached with a seatbelt of a vehicle.

8. The system for an escaping device as claimed in claim 1 comprises:
the storage compartment comprises an exterior wall, an interior wall, a first lateral wall, a second lateral wall, a bottom enclosure, a holster opening, and a logo section;
the interior wall being adjacently positioned with the seatbelt attachment mechanism;
the exterior wall being connected to the interior wall by the first lateral wall and the second lateral wall;
the exterior wall being oppositely positioned from the seatbelt attachment mechanism;
the first lateral wall and the second lateral wall being oppositely positioned from each other across the exterior wall and the interior wall;
the first lateral wall and the second lateral wall being perpendicularly positioned with the exterior wall and the interior wall;
the bottom enclosure being positioned in between the first lateral wall, the second lateral wall, the exterior wall, and the interior wall from an end;
the holster opening being oppositely positioned from the bottom enclosure; and
the logo section being centrally positioned on the exterior wall opposite from the interior wall.

9. A system for an escaping device comprises:
an escape device;
a holster;
the escape device comprises a first portion and a second portion;
the first portion comprises a glass breaking protrusion and a locking mechanism;
the second portion comprises a light emitting diode (LED), a power switch, a battery compartment, a plurality of indentations, and a seatbelt cutter;
the holster comprises a storage compartment and a seatbelt attachment mechanism;
the first portion and the second portion being adjacently positioned with each other;
the glass breaking protrusion being positioned on the first portion opposite from the second portion;
the locking mechanism being positioned on the first portion; and
the escape device being secured within the holster.

10. The system for an escaping device as claimed in claim 9 comprises:
the plurality of indentations being perimetrically positioned on the second portion;
the plurality of indentation being adjacently positioned with the first portion;
the seatbelt cutter being diagonally extended into the second portion opposite from the plurality of indentations; and
the seatbelt cutter being adjacently positioned with the first portion.

11. The system for an escaping device as claimed in claim 10 comprises:
the seatbelt cutter comprises a recessed opening, a first railing, a second railing, a first blade, and a second blade;
the recessed opening being adjacently positioned with the first portion and extended into the second portion;
the first railing and the second railing being oppositely positioned each other;
the first blade being connected to the first railing and angularly extended into the recessed opening; and
the second blade being connected to the second railing and angularly extended up to the first blade.

12. The system for an escaping device as claimed in claim 9 comprises:
the LED being perimetrically positioned on the second portion opposite from the first portion;
the power switch being positioned on the second portion adjacent to the LED;
the battery compartment being positioned within the second portion adjacent to the LED and the power switch; and
the LED, the power switch, and the battery compartment being electrically connected to each other.

13. The system for an escaping device as claimed in claim 9 comprises:
the storage compartment being adjacently connected atop the seatbelt attachment mechanism;
the escape device being removably attached with the storage compartment by the locking mechanism; and
the seatbelt attachment mechanism being removably and adjustably attached with a seatbelt of a vehicle.

14. The system for an escaping device as claimed in claim 9 comprises:
the storage compartment comprises an exterior wall, an interior wall, a first lateral wall, a second lateral wall, a bottom enclosure, a holster opening, and a logo section;
the interior wall being adjacently positioned with the seatbelt attachment mechanism;
the exterior wall being connected to the interior wall by the first lateral wall and the second lateral wall;
the exterior wall being oppositely positioned from the seatbelt attachment mechanism;
the first lateral wall and the second lateral wall being oppositely positioned from each other across the exterior wall and the interior wall;
the first lateral wall and the second lateral wall being perpendicularly positioned with the exterior wall and the interior wall;
the bottom enclosure being positioned in between the first lateral wall, the second lateral wall, the exterior wall, and the interior wall from an end;
the holster opening being oppositely positioned from the bottom enclosure; and
the logo section being centrally positioned on the exterior wall opposite from the interior wall.

15. A system for an escaping device comprises:
an escape device;
a holster;
the escape device comprises a first portion and a second portion;
the first portion comprises a glass breaking protrusion and a locking mechanism;
the second portion comprises a light emitting diode (LED), a power switch, a battery compartment, a plurality of indentations, and a seatbelt cutter;
the holster comprises a storage compartment and a seatbelt attachment mechanism;
the first portion and the second portion being adjacently positioned with each other;
the glass breaking protrusion being positioned on the first portion opposite from the second portion;
the locking mechanism being positioned on the first portion;
the storage compartment being adjacently connected atop the seatbelt attachment mechanism;
the escape device being removably attached with the storage compartment by the locking mechanism; and
the seatbelt attachment mechanism being removably and adjustably attached with a seatbelt of a vehicle.

16. The system for an escaping device as claimed in claim 15 comprises:
the plurality of indentations being perimetrically positioned on the second portion;
the plurality of indentation being adjacently positioned with the first portion;
the seatbelt cutter being diagonally extended into the second portion opposite from the plurality of indentations; and
the seatbelt cutter being adjacently positioned with the first portion.

17. The system for an escaping device as claimed in claim 16 comprises:
the seatbelt cutter comprises a recessed opening, a first railing, a second railing, a first blade, and a second blade;
the recessed opening being adjacently positioned with the first portion and extended into the second portion;
the first railing and the second railing being oppositely positioned each other;
the first blade being connected to the first railing and angularly extended into the recessed opening; and
the second blade being connected to the second railing and angularly extended up to the first blade.

18. The system for an escaping device as claimed in claim 15 comprises:
the LED being perimetrically positioned on the second portion opposite from the first portion;
the power switch being positioned on the second portion adjacent to the LED;
the battery compartment being positioned within the second portion adjacent to the LED and the power switch; and
the LED, the power switch, and the battery compartment being electrically connected to each other.

19. The system for an escaping device as claimed in claim 15 comprises:
the storage compartment comprises an exterior wall, an interior wall, a first lateral wall, a second lateral wall, a bottom enclosure, a holster opening, and a logo section;
the interior wall being adjacently positioned with the seatbelt attachment mechanism;
the exterior wall being connected to the interior wall by the first lateral wall and the second lateral wall;
the exterior wall being oppositely positioned from the seatbelt attachment mechanism;
the first lateral wall and the second lateral wall being oppositely positioned from each other across the exterior wall and the interior wall;
the first lateral wall and the second lateral wall being perpendicularly positioned with the exterior wall and the interior wall;
the bottom enclosure being positioned in between the first lateral wall, the second lateral wall, the exterior wall, and the interior wall from an end;
the holster opening being oppositely positioned from the bottom enclosure; and
the logo section being centrally positioned on the exterior wall opposite from the interior wall.
